(19) United States
(12) Patent Application Publication
(10) Pub. No.: US 2007/0177337 A1
(43) Pub. Date: Aug. 2, 2007

(54) Electronic device

(75) Inventors: Toshifumi Sasaoka, Echizen-city (JP); Daisuke Shimizu, Echizen-city (JP); Takayuki Horie, Echizen-city (JP); Masateru Yamamoto, Echizen-city (JP); Yoshimoto Tanaka, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/655,881

(22) Filed: Jan. 22, 2007

(30) Foreign Application Priority Data
Jan. 31, 2006 (JP) 2006-022130

(51) Int. Cl. H02B 1/00

(52) U.S. Cl. 361/600

(57) ABSTRACT

The invention provides an electronic device which has a connecting means for assembling a front and top panels, and a position restricting means for restricting the position of the top panel. The connecting means is composed of a tongue block extending substantially horizontally with respect to the top panel from a front end of a bent block bent downward from the front side of the top panel, an insertion block extending downward from the end of the bent block by cutting off a portion of the tongue block, and a supporting block having an insertion hole to which is fit the insertion block extended rearward from the inner side of the front panel. The position restricting means is composed of a through hole formed to the bent block and a projection fit to the through hole extended rearward from the inner side of the front panel.

The present application is based on and claims priority of Japanese patent application No. 2006-022130 filed on Jan. 31, 2006, the entire contents of which are hereby incorporated by reference.

### BACKGROUND OF THE INVENTION

1. Field of the Invention

The present invention relates to an electronic device having its exterior composed of a front panel, a top panel and a chassis, and more specifically, relates to an electronic device capable of preventing the components constituting the exterior thereof from being easily removed after assembly, and capable of restricting the position of the top panel assembled to the front panel.

2. Description of the Related Art

Conventionally, electronic devices such as CD players, DVD players, DVD recorders and video cassette recorders are composed by assembling a reproducing or recording and reproducing unit (hereinafter referred collectively as recording and reproducing unit) and electronic components including power boards and various control boards onto a chassis, and then assembling a front panel to the front side of the chassis and assembling a top panel from the upper side of the chassis.

In further detail, the front panel is fixed to the chassis via a locking means such as a hook, the top panel covering the upper side of the chassis is substantially U-shaped so that both sides thereof are bent downward or toward the chassis, and the corresponding sides of the chassis are slightly bent upward or toward the top panel so as to form overlap portions with the top panel, so that engagement members such as screws can be used to fix the top panel to the chassis at the overlap portions.

The front panel is often formed of synthetic resin, and the top panel is often formed by bending a metal plate member, so that a gap may be formed at the connection between the members formed of different materials due to dimension error, deformation and deflection, for example, which may result in deterioration of the quality of the electronic device product. That is, if size is dispersed during formation of the front panel made of synthetic resin, or if the metallic top panel is deflected and deformed, there is a drawback in that a gap may be formed at the connection between the front panel and the top panel being assembled, or the upper surface of the front panel may be deformed by the influence of the deflected and deformed top panel.

The above-mentioned drawback affects the exterior size of the electronic device, and in an electronic device having a greater depth then height and greater width then depth, apparent gaps may appear at the connection between the front panel and the top panel, especially at the connection at the upper portion of the electronic device even due to minute dimension error and deformation. Therefore, various measures have been proposed.

Japanese patent application laid-open publication No. 2005-294728 (patent document 1) discloses an art of eliminating gaps at the connection between the front panel and the top panel. Actually, a coupling means that couples the upper plate portion of the front panel and a sheet-metal top panel of the top cover has a support coupling mechanism composed of a fitting piece formed to the top panel and a recess fitting portion, a fitting piece support, a contact portion and a receiving portion formed to the front panel, a support mechanism composed of a leg formed to the top panel and a slide face formed to the front panel, and a screw clamp, wherein by sliding a sliding portion of the leg on the sliding surface, the fitting piece fits into the recess fitting portion from above through an assembly action that brings the top cover close to the front panel from behind.

The application of the art disclosed in patent document 1 may enable the front panel and the top panel to be assembled without a gap, but it may cause the following drawbacks.

The first drawback is that displacement and deflection may easily occur. According to the art disclosed in patent document 1, since a through hole capable of having a screw inserted thereto is formed on the screw engaging position of the top panel, and the top panel is screw-engaged to the overlap portion of the chassis by inserting a screw to the through hole, the top panel may be displaced within the range of the through hole and fixed. In other words, when the top panel is assembled to the front panel, the top panel may be displaced with respect to the front panel in the height direction of the device, that is, the perpendicular direction when the electronic device is installed on a horizontal plane. Furthermore, since a support coupling mechanism is disposed on both sides of the front panel, deflection other than the displacement of the top panel may occur at the center portion of the electronic device. Especially in a stationary device such as a DVD recorder, the width thereof may be greater than the other sizes, that are the height and depth of the device, and therefore, the side of the upper surface where the front panel and the top panel are connected is long, so that the displacement and deflection appear significant.

Another drawback is that the top panel can be removed easily. According to the art disclosed in patent document 1, the top panel is fixed merely via screws, so that the top panel can be removed easily by disengaging the screws. Therefore, for example, a user may disengage the screws of the electronic device to remove the top panel covering the upper portion of the electronic device and carelessly touch components inside the electronic device, which may lead to firing or electric shock.

Another problem is the increase of costs. According to the art disclosed in patent document 1, a support coupling mechanism is disposed on both sides of the front panel, but since the fitting piece of the top panel is to be slid and fit to position, the forming thereof is difficult and the molds to be used become complex, according to which the costs are increased.

### SUMMARY OF THE INVENTION

The present invention aims at solving the problems described above by providing an electronic device capable of suppressing the occurrence of gaps between the front panel and the top panel, and also capable of suppressing the displacement of the top panel, preventing removal of the top panel and cutting down costs.

A first aspect of the present invention provides an electronic device having a chassis, a front panel assembled to a front side of the chassis, and a top panel covering an upper side of the chassis that constitute an exterior of the electronic device, comprising a connecting means for assembling the front panel and the top panel; and a position restricting means for restricting the position of the top panel with respect to the front panel.

According to the electronic device of aspect 1, a connecting means can be used to assemble the front panel and the top panel, and in addition, a position restricting means can restrict the position of the top panel with respect to the front panel.

A second aspect of the present invention provides an electronic device according to aspect 1, wherein the connecting means is composed of a tongue block extending substantially horizontally with respect to the top panel from an end of a bent block bent downward from a front area of the top panel, an insertion block extending downward from an end of the bent block by cutting off a portion of the tongue block, and an insertion hole extended rearward from an inner side of the front panel into which the insertion block is fit.

According to the electronic device of aspect 2, a connecting means having a simple shape can be used to assemble the front panel and the top panel by having an insertion block formed to the top panel fit to an insertion hole formed on the supporting block of the front panel, and to restrict the position of the top panel in the depth direction with respect to the front panel.

A third aspect of the present invention provides an electronic device according to aspects 1 or 2, wherein the position restricting means is composed of a through hole formed to a bent block bent downward from a front area of the top panel, and a projection passed through a through hole extended rearward from an inner side of the front panel.

According to the electronic device of aspect 3, a position restricting means having a simple shape can be used to restrict the position of the top panel in the height direction with respect to the front panel by having the projection of the front panel passed through a through hole formed to the top panel.

A fourth aspect of the present invention provides an electronic device according to any one of aspects 1 through 3, wherein the connecting means is provided to the area near both side portions of the front panel and the top panel, respectively, and one or a plurality of position restricting means is provided between the connecting means.

According to the electronic device of aspect 4, the connecting means and the position restricting means can be arranged efficiently.

A fifth aspect of the present invention provides an electronic device according to any one of aspects 1 through 4, wherein a depth thereof is greater than a height thereof, and a width thereof is greater than the depth thereof.

According to the electronic device of aspect 5, the present invention can be applied to the assembling and positioning of a front panel and a top panel of an electronic device designed so that the depth thereof is greater than the height thereof and the width thereof is greater than the depth thereof, which is generally the most popular design of a stationary electronic device product.

### BRIEF DESCRIPTION OF THE DRAWINGS

FIG. 1 is an exploded perspective view showing the front panel, the top panel and the chassis constituting the exterior of the electronic device according to the preferred embodiment of the present invention;

FIG. 2 is a perspective view showing the inner side of the front panel according to the same;

FIG. 3 is a cross-sectional perspective view showing the configuration near the support block of the front panel according to the same;

FIG. 4 is a cross-sectional perspective view showing the configuration near the projection of the front panel according to the same;

FIG. 5 is a perspective view showing the top panel according to the same;

FIG. 6 is a perspective view showing the area near the insertion block of the top panel according to the same;

FIG. 7 is a perspective view showing the area near the through hole of the top panel according to the same;

FIG. 8 is a cross-sectional side view showing the state of the area near the connecting means prior to assembling the top panel to the front panel according to the same;

FIG. 9 is a cross-sectional side view showing the state of the area near the connecting means after assembling the top panel to the front panel according to the same;

FIG. 10 is a cross-sectional side view showing the state of the area near the position restricting means prior to assembling the top panel to the front panel according to the same; and

FIG. 11 is a cross-sectional side view showing the state of the area near the position restricting means after assembling the top panel to the front panel according to the same.

### DETAILED DESCRIPTION OF THE PREFERRED EMBODIMENTS

The preferred embodiment of the present invention is described with reference to the drawings. The following embodiment is a mere example for realizing the present invention, and is not intended to limit the scope of the present invention.

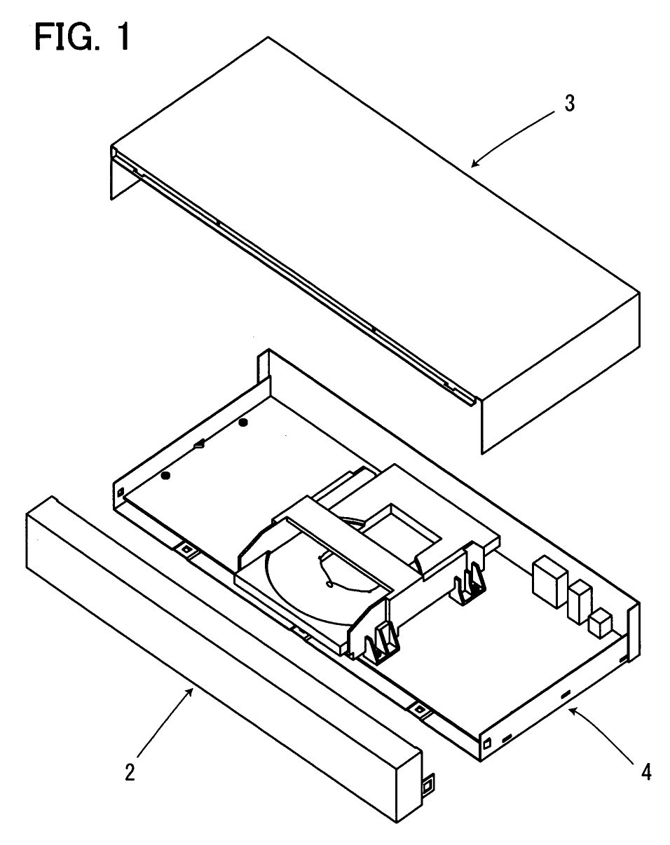

FIG. 1 is an exploded perspective view illustrating a front panel 2, a top panel 3 and a chassis 4 that constitute the exterior of the electronic device of the present embodiment, and on the chassis 4 shown in the drawing are assembled electronic components. The top panel 3 covering the upper side of the chassis 4 is formed substantially in a U-shape having both sides bent toward the lower direction, or toward the chassis 4, and the corresponding side walls of the chassis 4 are bent slightly toward the upper direction, or toward the top panel 3, thereby forming overlap portions with the top panel 3. According to the present arrangement, the top panel 3 is assembled from the upper side of the chassis 4 after assembling the front panel 2 onto the front side of the chassis 4.

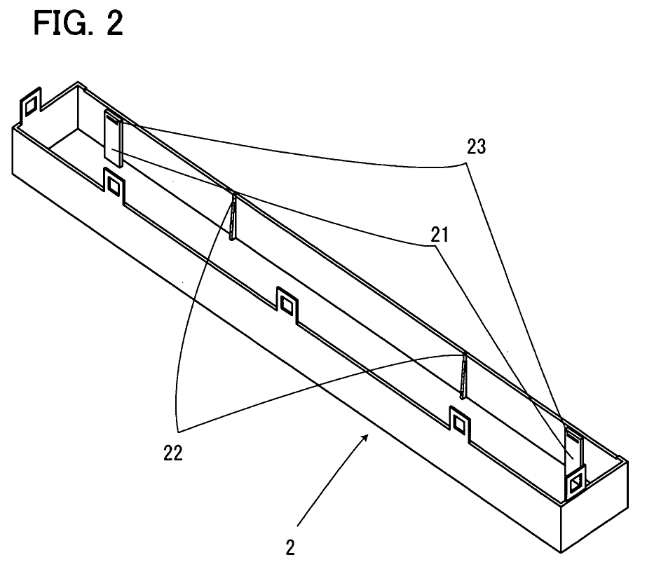

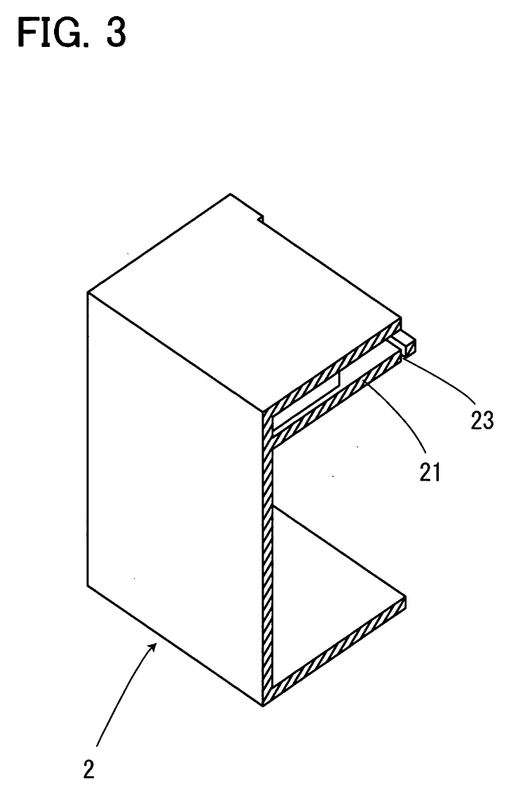

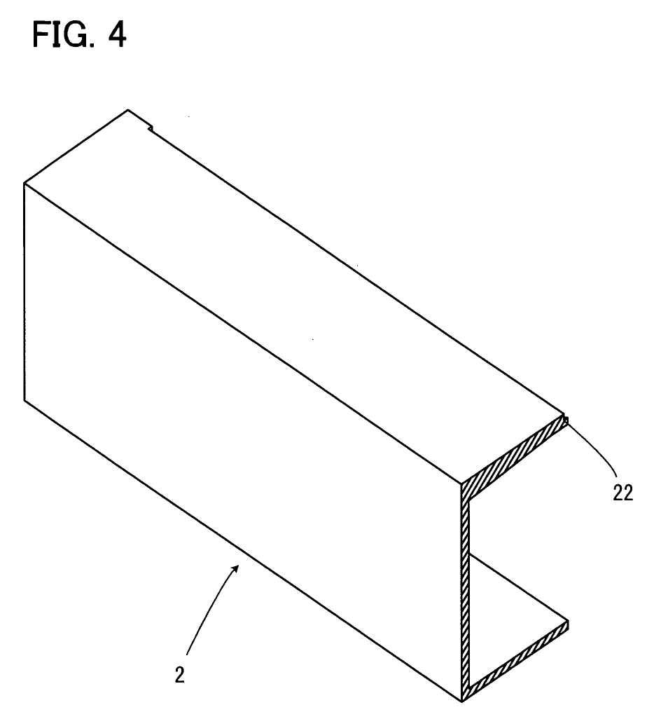

FIG. 2 is a perspective view showing the inner side of the front panel 2. Support blocks 21 are formed near both sides of the front panel 2 on the inner side that constitute insertion holes 23 extending rearward, or upward in FIG. 2, and projections 22 extending rearward, or upward in FIG. 2, are formed between the support blocks 21. FIG. 3 is a cross-sectional perspective view showing the shape near the support block 21 of the front panel 2. FIG. 4 is a cross-sectional perspective view showing the shape near the projection 22 of the front panel 2.

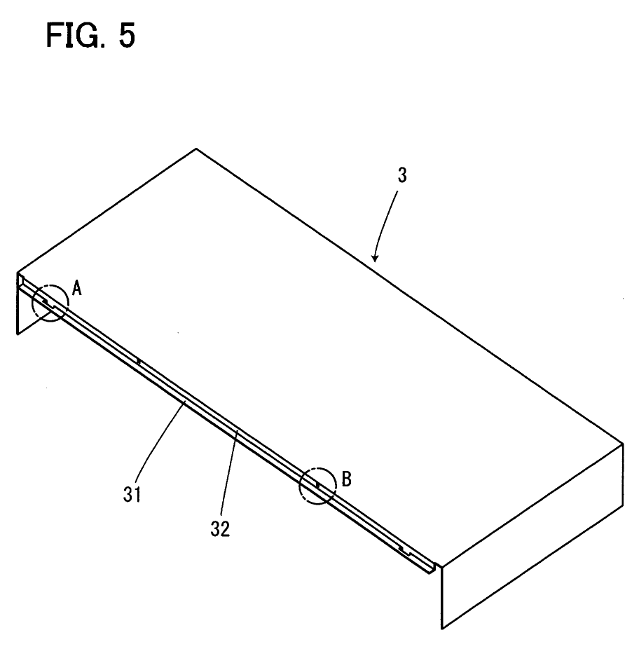

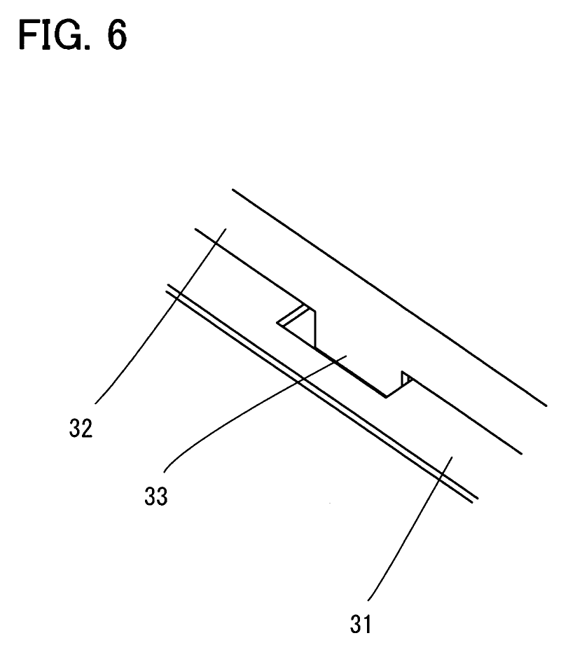

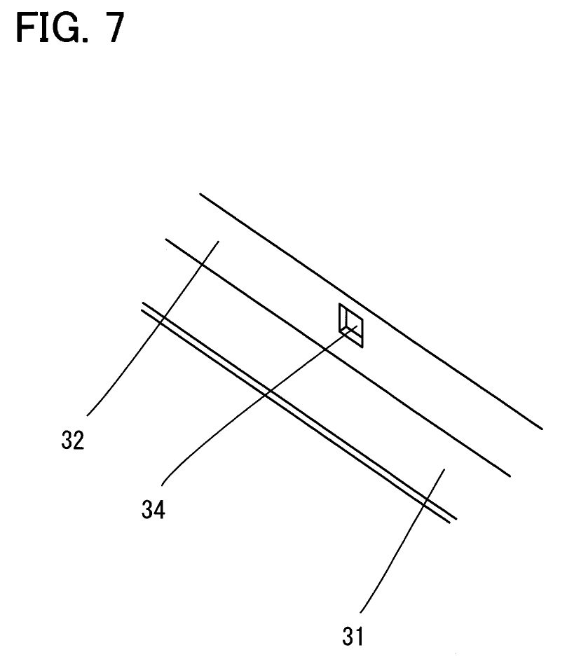

FIG. 5 is a perspective view illustrating the top panel 3, having a bent block 32 formed to bend downward at the front area of the top panel 3, and on the end of the bent block 32 is formed a tongue block 31 formed to extend substantially horizontally with respect to the top panel 3. Further, the top panel has an insertion block 33 formed to cut off a portion of the tongue block 31 to extend downward from the end of the bent block 32, and a through hole 34 formed to the bent block 32. Circle A shows the position where the insertion block 33 is formed, and circle B shows the position where the through hole 34 is formed. FIG. 6 is a perspective view showing the area near the insertion block 33, inside circle A of FIG. 5. FIG. 7 is a perspective view showing the area near the through hole 34, inside circle B of FIG. 5.

A function of a connecting means is realized by fitting the insertion block 33 into the insertion hole 23 formed to the support block 21. Further, a function of a position restricting means is realized by fitting the projection 22 to the through hole 34.

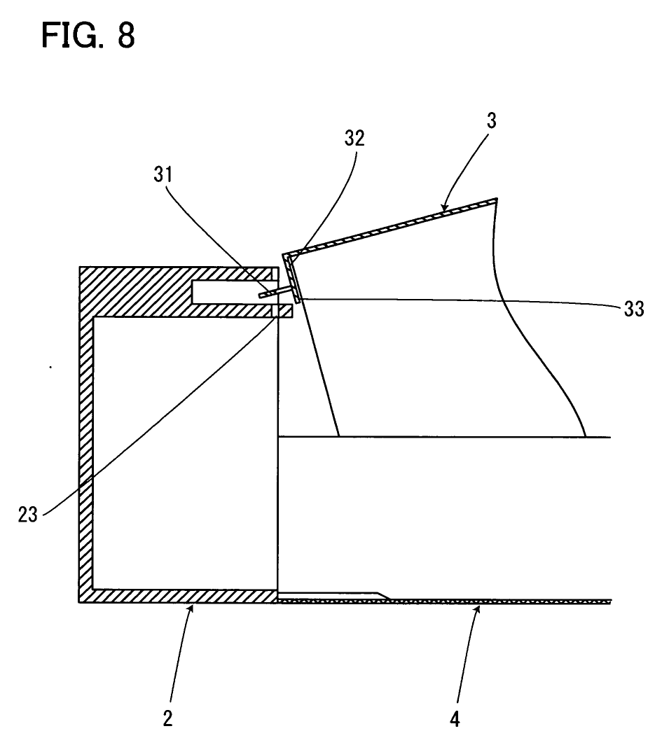

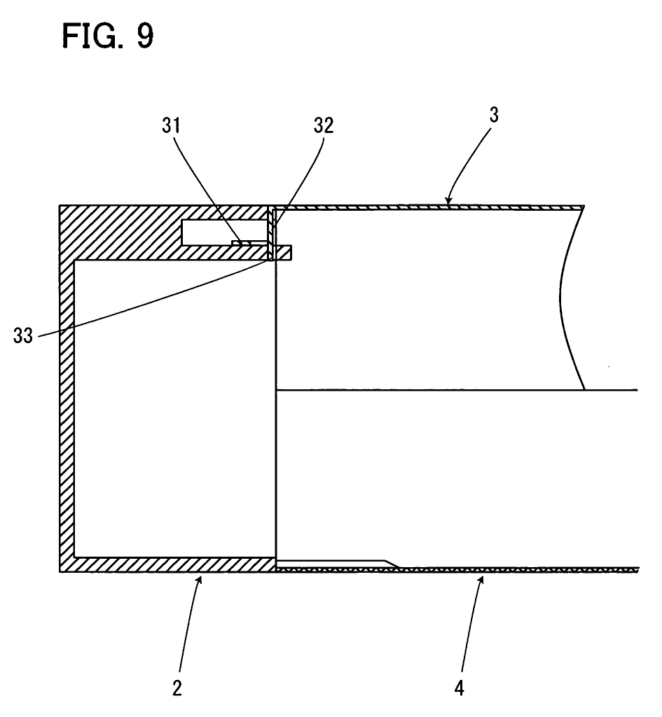

FIG. 8 is a cross-sectional side view showing the state near the connecting means prior to assembling the top panel 3 to the front panel 2, and FIG. 9 is a cross-sectional side view showing the state near the connecting means after assembling the top panel 3 to the front panel 2. Thus, the assembly of the front panel 2 and the top panel 3, and the positional restriction in the depth direction, which in FIGS. 8 and 9 is the lateral direction, is realized.

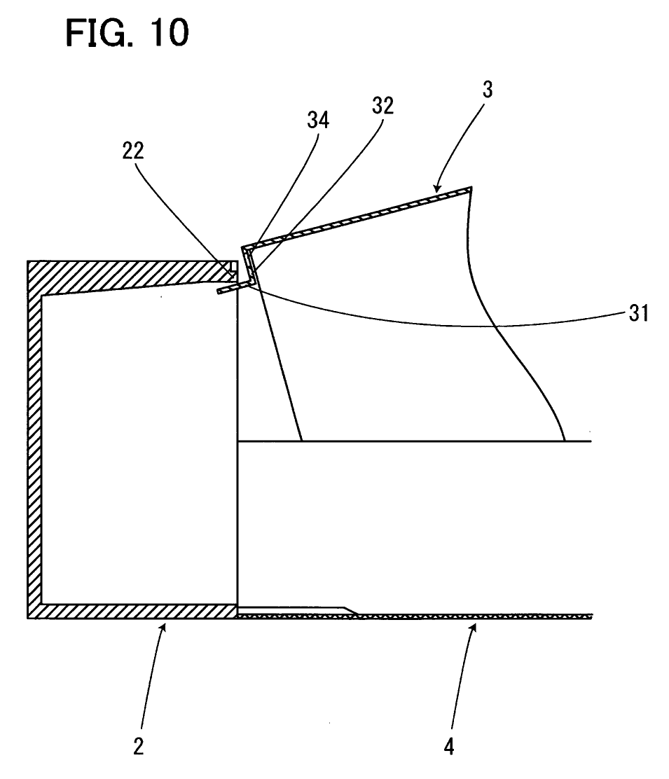

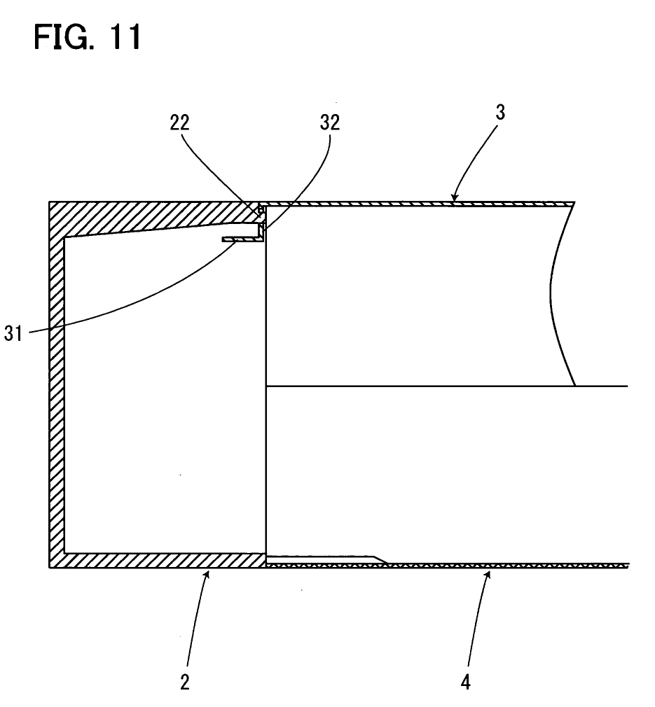

FIG. 10 is a cross-sectional side view showing the state near the position restricting means prior to assembling the top panel 3 to the front panel 2, and FIG. 11 is a cross-sectional side view showing the state near the position restricting means after assembling the top panel 3 to the front panel 2. Thus, it becomes possible to realize the positional restriction in the height direction, which in FIGS. 10 and 11 is the vertical direction.

As described, the present invention enables to provide an electronic device capable of suppressing the generation of gaps between the front panel and the top panel. Moreover, the present invention enables to provide an electronic device capable of suppressing the positional displacement of the top panel. Furthermore, the present invention enables to provide an electronic device capable of preventing the top panel from being removed easily after assembly. Even further, the present invention enables to provide an electronic device that can be formed easily.

The effects of the present invention are as follows.

According to the present invention, a connecting means is used to assemble the front panel and the top panel, and in addition, a position restricting means is used to restrict the position of the top panel with respect to the front panel, so it becomes possible to provide an electronic device capable of suppressing the occurrence of gaps between the front panel and the top panel.

Further according to the present invention, since a position restricting means is used to restrict the position of the top panel in the height direction with respect to the front panel, it becomes possible to provide an electronic device capable of suppressing the displacement of the top panel.

Even further according to the present invention, since the connecting means and the position restricting means can restrict the position both in the depth direction and in the height direction, and since the connecting means is used to assemble the front panel and the top panel, it becomes possible to provide an electronic device capable of preventing the top panel from being removed easily after assembly. Thus, it becomes possible to prevent the user from accidentally touching the components arranged in the interior of the electronic device.

Further according to the present invention, since the connecting means and the position restricting means can be realized via a simple shape, and the connecting means and the position restricting means can be arranged efficiently, it becomes possible to provide an electronic device that can be formed easily. Thus, it becomes possible to cut down the costs of molds.

Even further according to the present invention, the above-mentioned effects can be achieved by an electronic device having an exterior design that is generally used in a stationary product, which is formed so that its depth is greater than its height and its width is greater than its depth, so that it becomes possible to provide an electronic device having such exterior design.

1. An electronic device having a chassis, a front panel assembled to a front side of the chassis, and a top panel covering an upper side of the chassis that constitute an exterior of the electronic device, comprising:
a connecting means for assembling the front panel and the top panel; and
a position restricting means for restricting the position of the top panel with respect to the front panel.

2. The electronic device according to claim 1, wherein the connecting means is composed of a tongue block extending substantially horizontally with respect to the top panel from an end of a bent block bent downward from a front area of the top panel, an insertion block extending downward from the end of the bent block by cutting off a portion of the tongue block, and an insertion hole extended rearward from an inner side of the front panel into which the insertion block is fit.

3. The electronic device according to claim 1, wherein the position restricting means is composed of a through hole formed to a bent block bent downward from a front area of the top panel, and a projection passed through a through hole extended rearward from an inner side of the front panel.

4. The electronic device according to claim 1, wherein the connecting means is provided to the area near both side portions of the front panel and the top panel, respectively, and one or a plurality of position restricting means is provided between the connecting means.

5. The electronic device according to claim 1, wherein a depth thereof is greater than a height thereof, and a width thereof is greater than the depth thereof.

6. The electronic device according to claim 2, wherein the position restricting means is composed of a through hole formed to a bent block bent downward from a front area of the top panel, and a projection passed through a through hole extended rearward from an inner side of the front panel.

7. The electronic device according to claim 2, wherein the connecting means is provided to the area near both side portions of the front panel and the top panel, respectively, and one or a plurality of position restricting means is provided between the connecting means.

8. The electronic device according to claim 3, wherein the connecting means is provided to the area near both side portions of the front panel and the top panel, respectively, and one or a plurality of position restricting means is provided between the connecting means.

9. The electronic device according to claim 6, wherein the connecting means is provided to the area near both side portions of the front panel and the top panel, respectively, and one or a plurality of position restricting means is provided between the connecting means.

10. The electronic device according to claim 2, wherein a depth thereof is greater than a height thereof, and a width thereof is greater than the depth thereof.

11. The electronic device according to claim 3, wherein a depth thereof is greater than a height thereof, and a width thereof is greater than the depth thereof.

12. The electronic device according to claim 4, wherein a depth thereof is greater than a height thereof, and a width thereof is greater than the depth thereof.

13. The electronic device according to claim 6, wherein a depth thereof is greater than a height thereof, and a width thereof is greater than the depth thereof.

14. The electronic device according to claim 7, wherein a depth thereof is greater than a height thereof, and a width thereof is greater than the depth thereof.

15. The electronic device according to claim 8, wherein a depth thereof is greater than a height thereof, and a width thereof is greater than the depth thereof.

16. The electronic device according to claim 9, wherein a depth thereof is greater than a height thereof, and a width thereof is greater than the depth thereof.
